(19) United States
(12) Patent Application Publication
(10) Pub. No.: US 2022/0004874 A1
(43) Pub. Date: Jan. 6, 2022

(54) ELECTRONIC APPARATUS TRAINING INDIVIDUAL MODEL OF USER AND METHOD OF OPERATING THE SAME

(71) Applicant: Samsung Electronics Co., Ltd., Suwon-si (KR)

(72) Inventors: James Russell GERACI, Suwon-si (KR); Kyunghwan LEE, Suwon-si (KR)

(73) Assignee: Samsung Electronics Co., Ltd., Suwon-si (KR)

(21) Appl. No.: 17/480,859

(22) Filed: Sep. 21, 2021

Related U.S. Application Data
(63) Continuation of application No. PCT/KR2020/002150, filed on Sep. 9, 2020.

(51) Int. Cl. G06N 3/08; G06K 9/62; G06N 3/10

(52) U.S. Cl. CPC G06N 3/08; G06F 17/15; G06N 3/10; G06K 9/6256

(57) ABSTRACT

A method and an electronic apparatus for training a personal model of a user are provided. The method includes obtaining first information including personal data of the user represented as a first constituent element of the personal model; obtaining second information including group data of a plurality of users in a group to which the user belongs, represented as a second constituent element of the personal model; determining a first weight value and a second weight value to be respectively applied to the first information and the second information based on reliability of the first information; and training the personal model based on the first information and the second information to which the first weight value and the second weight value are respectively applied.

### CROSS-REFERENCE TO RELATED APPLICATION(S)

This application is a by-pass continuation of International PCT Application No. PCT/KR2020/012150 filed Sep. 9, 2020, which is based on and claims priority to Korean Patent Application No. 10-2020-0009312 filed Jan. 23, 2020 in the Korean Intellectual Property Office, the disclosures of which are incorporated by reference herein in their entireties.

### BACKGROUND

### 1. Field

The disclosure relates to an electronic apparatus for training a personal model of a user and a method of operating the same.

### 2. Description of Related Art

Electronic apparatuses may provide various services to a user by using a personal model trained based on various types of personal data collected in relation to the user.

However, when an amount of personal data for training the personal model is not sufficient or the accuracy or reliability of the collected personal data is low, it may be difficult to provide the user with an appropriate service according to the personal model.

Therefore, there is a need for a method of providing a highly reliable trained personal model even when personal data for training the personal model is insufficient.

### SUMMARY

Provided are an electronic apparatus for training a personal model of a user and a method of operating the same.

Also provided is a computer-readable recording medium having recorded thereon a program for executing the method on a computer.

Additional aspects will be set forth in part in the description which follows, and in part, will be apparent from the description, or may be learned by practice of the presented embodiments.

According to an embodiment, there is provided a method of training a personal model of a user, performed by an electronic apparatus. The method includes: obtaining first information including personal data of the user represented as a first constituent element of the personal model; obtaining second information including group data of a plurality of users in a group to which the user belongs, represented as a second constituent element of the personal model; determining a first weight value and a second weight value to be respectively applied to the first information and the second information based on reliability of the first information; and training the personal model based on the first information and the second information to which the first weight value and the second weight value are respectively applied.

The reliability of the first information indicates a degree to which an operation according to the personal model corresponds to a user preference.

The reliability of the first information is determined based on at least one from among an amount of the personal data used to obtain the first information, a magnitude of a loss function indicating a difference between observation information and prediction information which are used to obtain the first information, a number of iterations for which the personal model is trained based on the first information and the second information, and a correlation between the plurality of users and the user.

The first weight value and the second weight value are determined so that a sum of the first weight value and the second weight value is equal to 1.

The group data includes information related to a plurality of personal models trained based on pieces of personal data respectively collected with respect to the plurality of users.

The information related to the plurality of personal models includes constituent elements of the plurality of personal models and an out-degree with respect to each of the plurality of personal models, and the out-degree indicates a number of personal models among the plurality of personal models affecting at least one personal model among the plurality of personal models.

The plurality of users are grouped based on a similarity between pieces of personal data of each of the plurality of users.

According to an embodiment, there is provided an electronic apparatus for training a personal model of a user, the electronic apparatus including: at least one processor configured to: control a communication interface to obtain first information including personal data of the user represented as a first constituent element of the personal model; control the communication interface to obtain second information including group data of a plurality of users in a group to which the user belongs, represented as a second constituent element of the personal model; determine a first weight value and a second weight value to be respectively applied to the first information and the second information based on reliability of the first information; train the personal model based on the first information and the second information to which the first weight value and the second weight value are respectively applied, train the personal model; and control an output interface to output a result of an operation performed based on the trained personal model.

The reliability of the first information indicates a degree to which the operation according to the personal model corresponds to a user preference.

The reliability of the first information is determined based on at least one from among an amount of the personal data used to obtain the first information, a magnitude of a loss function indicating a difference between observation information and prediction information, which are used to obtain the first information, a number of iterations for which the personal model is trained based on the first information and the second information, and a correlation between the plurality of users and the user.

The first weight value and the second weight value are determined so that a sum of the first weight value and the second weight value is equal to 1.

The group data includes information related to a plurality of personal models trained based on pieces of personal data respectively collected with respect to the plurality of users.

The information related to the plurality of personal models includes constituent elements of the plurality of personal models and an out-degree with respect to each of the plurality of personal models, and the out-degree indicates a number of personal models among the plurality of personal models affecting at least one personal model among the plurality of personal models.

The plurality of users are grouped based on a similarity between pieces of personal data of each of the plurality of users.

According to an embodiment, there is provided a non-transitory computer-readable recording medium having recorded thereon a program for implementing the method provided above.

### BRIEF DESCRIPTION OF THE DRAWINGS

The above and other aspects, features and advantages of certain embodiments of the disclosure will be more apparent from the following description taken in conjunction with the accompanying drawings.

FIG. 1 is a block diagram of an example of an electronic apparatus for training a personal model of a user, according to an embodiment.

FIG. 2 is a diagram of an example of a plurality of personal models belonging to a group, according to an embodiment.

FIG. 3 is a diagram of an example of a personal model, according to an embodiment.

FIG. 4 is a block diagram illustrating an electronic apparatus, according to an embodiment.

FIG. 5 is a block diagram illustrating an electronic apparatus, according to an embodiment.

FIG. 6 is a flowchart illustrating a method of training a personal model, according to an embodiment.

### DETAILED DESCRIPTION

Hereinafter, embodiments of the disclosure will be described in detail with reference to the accompanying drawings such that one of ordinary skill in the art may readily practice the embodiments thereof. However, it should be understood that the disclosure may be embodied in different ways and is not limited to embodiments described herein. In addition, portions irrelevant to the description are omitted from the accompanying drawings for clarity, and like components are denoted by like reference numerals throughout the specification.

Throughout the specification, when an element is referred to as being “connected to” another element, the element may be “directly connected to” the other element, or the element may also be “electrically connected to” the other element with an intervening element therebetween. In addition, when an element is referred to as “including” or “comprising” another element, unless otherwise stated, the element may further include or comprise yet another element rather than preclude the yet other element.

Functions related to artificial intelligence (AI) according to the disclosure are operated through a processor and a memory. The processor may include at least one processor. The at least one processor may be a processor such as a central processing unit (CPU), an application processor (AP), a digital signal processor (DSP), a dedicated graphics processor such as a graphics processing unit (GPU) or a vision processing unit (VPU), or an artificial intelligence-dedicated processor such as a neural processing unit (NPU). The at least one processor may be controlled to process input data according to a predefined operation rule stored in the memory or an artificial intelligence model. Alternatively or additionally, when the at least one processor is an artificial intelligence-dedicated processor, the artificial intelligence-dedicated processor may be designed in a hardware structure specialized for processing a specific artificial intelligence model.

The predefined operation rule or the artificial intelligence model are made through training. Here, the expression “made through training” may mean that an existing AI model is trained based on a learning algorithm by using a large number of pieces of training data, and thus made into a predefined operation rule or an AI model, which is set to fulfill an intended feature. The training may be performed by a device itself, in which artificial intelligence according to the disclosure is performed, or may be performed through a separate server and/or system. Examples of the learning algorithm include supervised learning, unsupervised learning, semi-supervised learning, and reinforcement learning, but are not limited thereto.

An AI model may include a plurality of neural network layers. Each of the neural network layers has a plurality of node weight values and performs a neural network operation through an operation result of a previous layer and an operation between a plurality of weight values. The plurality of weight values that the neural network layers have may be optimized by a result of training of the artificial intelligence model. For example, the plurality of weight values may be refined to minimize a loss value or cost value obtained by the artificial intelligence model during a training process. An artificial neural network may include a deep neural network (DNN), and may be, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited thereto.

Hereinafter, the disclosure will be described in detail with reference to the accompanying drawings.

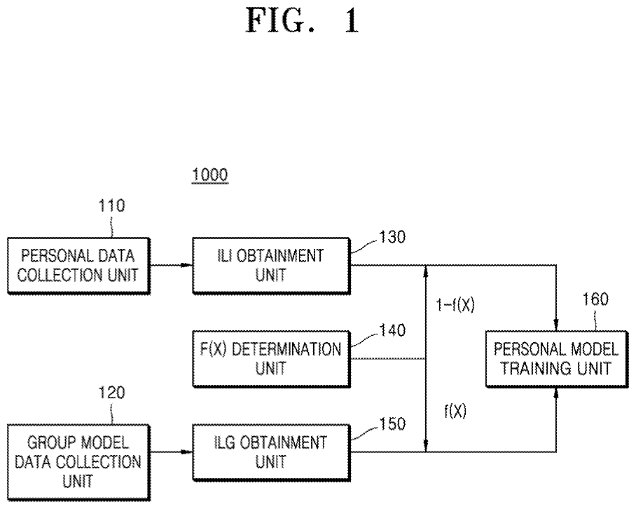

FIG. 1 is a block diagram of an example of an electronic apparatus 1000 training a personal model of a user, according to an embodiment.

Referring to FIG. 1, the electronic apparatus 1000 for training a personal model of a user may include a personal data collection unit 110, a group model data collection unit 120, an information learned from personal (ILI) obtainment unit 130, a f(x) determination unit 140, an information learned from group (ILG) obtainment unit 150, and a personal model training unit 160.

The electronic apparatus 1000 according to an embodiment may be implemented in various forms. For example, the electronic apparatus 1000 described herein may include, but is not limited to, a digital camera, a smart phone, a laptop computer, a tablet personal computer (PC), an electronic book (e-book) terminal, a digital broadcasting terminal, a personal digital assistant (PDA), a portable multimedia player (PMP), a navigation system, an MP3 player, or the like. The electronic apparatus 1000 described herein may include a wearable device that may be worn by a user. The wearable device may include, but is not limited to, at least one of an accessory type device (for example, a watch, a ring, a wristband, an ankle band, a necklace, glasses, or contact lenses), a head-mounted device (HMD), a fabric or clothing-integrated device (for example, electronic clothes), a body-attached device (for example, a skin pad), or a bio-implantable device (for example, an implantable circuit). Hereinafter, for convenience of description, descriptions will be made by taking an example in which the electronic apparatus 1000 is a smart phone.

The personal model according to an embodiment is an artificial intelligence model personalized with respect to a user of the electronic apparatus 1000, and may be used to provide various services to the user of the electronic apparatus 1000. According to an embodiment, a personal model corresponding to each of users may be trained based on different personal data collected with respect to each user. Thus, in response to being trained based on personal data collected with respect to each user, the personal model according to an embodiment may be used to provide a service suitable for each user.

Also, the personal model according to an embodiment may be an artificial intelligence model based on a neural network such as a deep neural network (DNN) and a recurrent neural network (RNN). The personal model is not limited to the above example, and may be various types of artificial intelligence models.

The personal model according to an embodiment may be trained based on personal data collected by the personal data collection unit 110. Also, the personal model according to an embodiment may be trained based on group model data collected by the group model data collection unit 120 as well as based on the personal data.

A user's personal data may be collected by the personal data collection unit 110 according to an embodiment and may include various types of information related to the user's personal context such as personal information, location information, information related to app usage, schedule information, and social network service (SNS) information. Thus, an appropriately personalized service may be provided to a user according to a personal model trained based on personal data.

Information about a user, which may be used to train a personal model, is not limited to above examples, and may include various other types of information related to the user for training the personal model so that a result personalized for the user is output.

The ILI obtainment unit 130 according to an embodiment may obtain information for training a personal model from personal data collected by the personal data collection unit 110, for example, based on the personal data, information for refining the personal model so that a result suitable for a user is output from the personal model.

The ILI according to an embodiment may include information about a constituent element constituting a personal model refined based on personal data according to the following Equation 1. For example, as shown in Equation 1 below, the ILI may include a constituent element constituting a personal model refined using personal data in step k+1 according to a result of an operation on the right side.

ILI=uᵢ^{k}+aᵢ^{k}g^{k}ᵤ [Equation 1]

In Equation 1, u is a constituent element constituting a personal model, and for example, may indicate a node weight value for each node and a bias value, which constitute an artificial intelligence model. According to an embodiment, the constituent element constituting the personal model, for example, at least one of the node weight values for each node or the bias value, may be refined based on personal data, and thus the personal model may be refined.

Moreover, i is an index value indicating a user (i) corresponding to the currently refined personal model, and k indicates a step in which the personal model is refined. According to an embodiment, an operation for refining the personal model for each step may be performed.

For example, based on ILI obtained based on u^{k} which is the personal model refined in step k and ILG to be described below, u^{k+1} which is the personal model refined in step k+1 may be obtained.

The electronic apparatus 1000 according to an embodiment may refine a personal model based on personal data by optimizing at least one of a plurality of node weight values and biases with respect to a plurality of neural network layers constituting the personal model. The node weight values indicate weight values that may be applied to each node constituting the personal model. For example, the electronic apparatus 1000 may refine a personal model based on personal data so that a difference between prediction information output via the personal model and observation information corresponding to the prediction information is minimized. Observation information according to an embodiment is information indicating a correct answer or value to prediction information and information that may be determined based on personal data.

According to an embodiment, observation information corresponding to prediction information that may be output from a personal model may be obtained based on personal data. That is, in Equation 1, a and g may be determined as values for modifying values constituting the personal model so that a difference between the observation information and the prediction information is minimized.

In Equation 1, a and g according to an embodiment are values that may be determined according to a point at which a value of a loss function indicating a difference between prediction information and observation information is minimized. For example, g may include a value indicating a slope of a point at which the value of the loss function is minimized with respect to each of a node weight value and a bias for each node constituting the personal model. Also, a may be a constant value applied to g, the combination of which is used to obtain u^{k+1} based on u^{k}. The disclosure is not limited to the above example, and a and g may be determined according to various methods for modifying values constituting a personal model so that a difference between the observation information and the prediction model is minimized.

However, when an amount of personal data collected by the personal data collection unit 110 according to an embodiment is not sufficient, reliability of a personal model trained based on ILI may be low. For example, when an amount of personal data used to train a personal model is not sufficient, information about a user is insufficiently reflected such that the personal model is not trained, and thus a service provided according to the personal model may not be suitable for the user.

Thus, the electronic apparatus 1000 according to an embodiment may train a personal model using not only ILI obtained based on personal data, but also group model data obtained from a group to which a user belongs.

Group model data that may be collected by the group model data collection unit 120 according to an embodiment may include information related to a plurality of personal models trained based on personal data respectively collected with respect to a plurality of users belonging to a group to which a user belongs.

For example, group model data may include information indicating constituent elements of personal models respectively corresponding to a plurality of users. The personal models respectively corresponding to the plurality of users may be artificial intelligence models respectively refined based on personal data collected with respect to each user.

Thus, the personal model according to an embodiment may be refined based on not only personal data, but also group model data including information about personal models respectively personalized with respect to a plurality of users.

A plurality of users of the group model data according to an embodiment may be grouped based on similarity between various pieces of information about each user, such as a tendency, age, and residency of each user. When a personal model of each of users is trained based on personal data including various information about the plurality of users, the plurality of users may be grouped based on similarity between pieces of the personal data respectively corresponding to the plurality of users. For example, the plurality of users may be grouped according to whether each user's surrounding environment, experience, personal information, and the like are similar to each other.

According to an embodiment, as correlation between various pieces of information about a plurality of users is higher, it may be determined that similarity is high.

For example, users whose ages and living areas are similar to each other may be classified into a same group. The disclosure is not limited to the above example, and a plurality of users according to an embodiment may be grouped according to various methods according to whether each user's life pattern, preference, context, and the like that are similar to each other, or may be randomly grouped without consideration for the similarity.

The ILG obtainment unit 150 according to an embodiment may include information obtained to train a personal model from group model data collected by the group model data collection unit 120. The ILG obtained by the ILG obtainment unit 150 according to an embodiment may include information for refining a personal model based on the group model data so that a result suitable for a user is output from the personal model. For example, ILG may include a constituent element of a user's personal model refined based on group model data.

The ILG according to an embodiment may be obtained based on group model data including information indicating constituent elements of personal models respectively corresponding to a plurality of users according to the following Equation 2. For example, as shown in Equation 2 below, the ILI may indicate a constituent element constituting a personal model refined based on group model data in step k+1 according to a result of an operation on the right side.

$$ILG = {u}_{i}^{k} + {\sum }_{j ∈ {N}_{i}}^{ } \frac{1}{2 max ( {d}_{i}^{k} , {d}_{j}^{k} )} ( {u}_{j}^{k} - {u}_{i}^{k} ) \qquad [ Equation 2 ]$$

In Equation 2, u is a constituent element constituting a personal model, along with u in Equation 1. Also, as described with reference to Equation 1, i is an index value indicating a user (i) corresponding to the currently refined personal model, and k indicates a step in which the personal model is refined according to an embodiment.

Here, j is an index value indicating other users belonging to a group to which the user (i) belongs.

Also, d is a value indicating an out-degree and indicates the number of a different user's personal models, which is affected by each model as group model data according to an embodiment. For example, in a case where a personal model for a user with j=3 is used as group model data when a personal model for a user with j=0, 2, or 4 is refined, dⱼ=d₃=3 may be determined.

Nᵢ indicates other users of a group to which i belongs, and thus j according to an embodiment may be determined as an index value of other users of a group to which i belongs.

The disclosure is not limited to the above example, and the group model data according to an embodiment may include information related to various types of personal data respectively collected with respect to a plurality of users as well as information about personal models respectively personalized with respect to a plurality of users or information obtained according to Equation 2.

Thus, according to an embodiment, even when personal data collected with respect to a user is insufficient, a personal model may be trained based on group model data collected with respect to other users whose preference is similar, and thus the accuracy and reliability of the personal model may be improved.

The f(x) determination unit 140 according to an embodiment may determine weight values to be applied to ILI and ILG obtained by the ILI obtainment unit 130 and the ILG obtainment unit 150. According to an embodiment, based on a f(x) determined according to the f(x) determination unit 140, a constituent element (uᵢ) of a personal model refined based on personal data and group model data may be obtained according to the following Equation 3.

uᵢ^{k+1}=(1−f(x))ILI+f(x)ILG [Equation 3]

According to an embodiment, in step k+1, a personal model of a user i may be refined based on a personal model corresponding to ILI and a personal model corresponding to ILG to which weight values are applied based on f(x).

According to the f(x) according to an embodiment, a degree to which the personal model of the ILG is reflected in the personal model of the user i may be adjusted by comparing to the personal model of the ILI. The f(x) according to an embodiment may be a constant value for adjusting a degree to which the personal model of the ILG is reflected in the personal model of the user i compared to the ILI. Here, x of the f(x) according to an embodiment indicates an arbitrary variable for determining the constant value, the f(x) of the constant value may be obtained based on x determined according to various methods.

The f(x) according to an embodiment may be determined so that the personal model of the ILG is less reflected in the personal model of the user i as the reliability of the personal model of the ILI is expected to be high. The reliability of a personal model according to an embodiment may indicate a degree to which an operation according to the personal model is accurate or suitable for a user.

For example, reliability of a personal model may indicate a degree to which an operation according to the personal model corresponds to a user's intention or preference. As a degree to which an operation according to a personal model according to an embodiment corresponds to a user's intention is greater, it is more likely that a result that the user wants is output by the personal model, and thus, reliability of the personal model may be determined to be higher. In a specific example, when a user's preference is to watch TV at 7 PM, the personal model may output information about various programs being played at different channels at 7 PM. The degree of reliability of providing such program information may be determined based on whether the personal model accurately detects and provides information related to the user's preference of watching TV at 7 PM.

The reliability of a personal model according to an embodiment may be determined based on various types of information related to training of the personal model.

For example, as an amount of personal data used to obtain ILI is greater, it is determined that reliability of the personal model of the ILI is high, and a f(x) value may be determined to be a low value.

Also, when a magnitude of a loss function indicating a difference between observation information and prediction information used to obtain ILI is closer to 0, it is determined that reliability of a personal model of ILI is high, and a f(x) value may be determined to be a low value.

Also, as a refining process is performed iteratively, that is, as the k value becomes greater, it may be determined that the reliability of a personal model of ILI is high, and a f(x) value may be determined to be a low value.

Also, as correlation between users in a group and a user i is greater, it is determined that reliability of a personal model of ILG is high, and a f(x) value may be determined to be a high value.

However, the disclosure is not limited to above examples, and a f(x) value according to an embodiment may be determined according to various methods based on reliability of a personal model refined based on personal data.

The personal model training unit 160 according to an embodiment may obtain a personal model (uᵢ^{k+1}) refined in step k+1 from ILI and ILG according to Equation 3 based on a f(x) determined by the f(x) determination unit 140.

Thus, according to an embodiment, even when reliability of a personal model refined using only personal data is low, a personal model refined according to group model data is also used, such that a personal model refined with high reliability may be obtained.

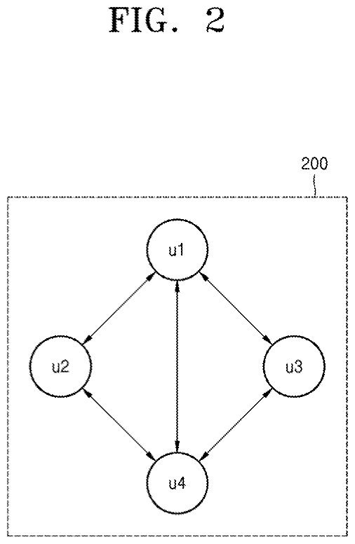

FIG. 2 is a diagram of an example of a plurality of personal models belonging to a group, according to an embodiment.

Referring to FIG. 2, in a group 200, there may be personal models u1, u2, u3, and u4 respectively corresponding to each of a plurality of users. Each of the personal models according to an embodiment may be refined according to not only ILI obtained based on personal data, but also according to ILG obtained based on another personal model belonging to the group 200.

For example, ILG for u1 among the personal models belonging to the group 200 may be obtained based on group model data including information related to the personal models of u2, u3, and u4. The group model data according to an embodiment is information related to respective personal models, and may include constituent elements (e.g., a node weight value for each node and a bias) of the personal models of u2, u3, and u4 and an out-degree (d) of each of the personal models.

According to an embodiment, according to arrows shown in FIG. 2, respective personal models u1, u2, u3, and u4 may affect, as group model data, other personal models when the other personal models are trained. For example, a personal model of u1 may be used as group model data when personal models of u2, u3, and u4 are trained. Also, a personal model of u2 may be used as group model data when personal models of u1 and u4 are trained. Also, a personal model of u3 may be used as group model data when personal models of u1 and u4 are trained. Also, a personal model of u4 may be used as group model data when personal models of u1, u2, and u3 are trained. Thus, out-degrees for u1, u2, u3, and u4 may be determined as 3, 2, 2, and 3, respectively.

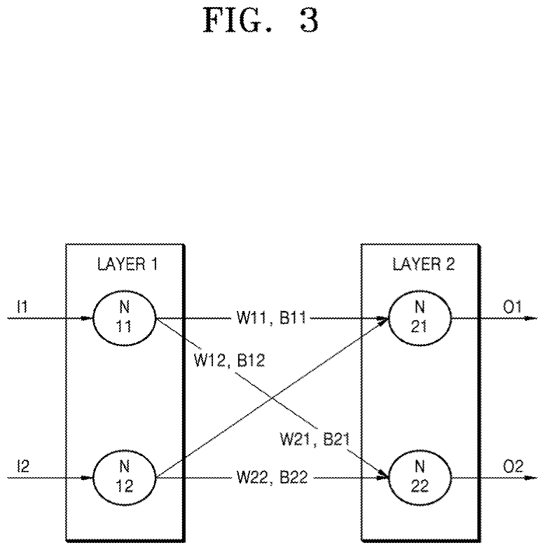

FIG. 3 is a diagram of an example of a personal model, according to an embodiment.

The personal model according to an embodiment may be configured as a neural network model that imitates a way the human brain recognizes a pattern. The electronic apparatus 1000 according to an embodiment may provide various services to a user by using the personal model configured as the neural network model.

The neural network according to an embodiment may be one of a deep neural network (DNN), a convolutional neural network (CNN), a recurrent neural network (RNN), a bidirectional recurrent deep neural network (BRDNN), a restricted Boltzmann machine (RBM), a deep belief network (DBN), and a deep Q-network. Also, the disclosure is not limited to the above example, and a local model or global model according to an embodiment may be one of various types of neural networks.

Referring to FIG. 3, the neural network model according to an embodiment may include at least one layer including at least one node. For example, the neural network model may include a layer 1 which is an input layer and a layer 2 which is an output layer. Also, the neural network model according to an embodiment may further include at least one hidden layer between the input layer and the output layer. Hereinafter, for convenience of descriptions, a neural network including the input layer and the output layer, except for the hidden layer, will be described as an example.

According to an embodiment, at least one input value may be input to the layer 1 of the neural network model. For example, values of I1 and I2 may be input to nodes N11 and N12 of the layer 1, respectively. According to an embodiment, in response to an input value being input to the layer 1, nodes N11, N12, N21, and N22 included in the layer 1 and layer 2 of the neural network model may be processed.

Also, a value output from the node of each layer may be used as an input value of a next layer. For example, certain values may be input to the nodes N21 and N22 of the layer 2 based on values obtained in response to the nodes N11 and N12 of the layer 1 being processed. A value output from the layer 2 may be output as an output value from the neural network model. For example, 01 and 02 which are values output from the layer 2 may be output as output values of the neural network model.

According to an embodiment, different node weight values may be applied to a value output from a node, and bias values may be added to the value output from the node. Accordingly, at least one piece of edge data may be obtained from the node. Edge data may be data that may be obtained by applying at least one node weight value to a value output from a node, and adding at least one bias value to at least one value to which each node weight value is applied. The edge data may be obtained as many as the number of node weight values applied to a value. Thus, a value output from each node of the layer 1 may be converted to at least one edge data and then input as a node of a next layer.

For example, edge data obtained by applying node weight values W11 and W12 to a value output from the node N11 and then adding bias values B11 and B12, respectively, may be input to the nodes N21 and N22 of a next layer, respectively. Also, edge data obtained by applying node weight values W21 and W22 to a value output from the node N12 and then adding bias values B21 and B22, respectively, may be input to the nodes N21 and N22 of a next layer, respectively.

According to an embodiment, a personal model may be trained by changing at least one node weight value that may be applied to each node and a bias value, which are values constituting the personal model, based on ILI and ILG.

ILI according to an embodiment may include at least one node weight value and bias values of a personal model so that a difference between prediction information and observation information obtained based on personal data is minimized.

Also, ILG according to an embodiment may include at least one node weight value and bias values of a personal model refined based on at least one node weight value and a bias value constituting a personal model of another user belonging to the same group.

Also, at least one node weight value and bias values of a personal model according to an embodiment may be refined in response to weight values being respectively applied to ILI and ILG according to Equation 3 based on a f(x) determined by the f(x) determination unit 140.

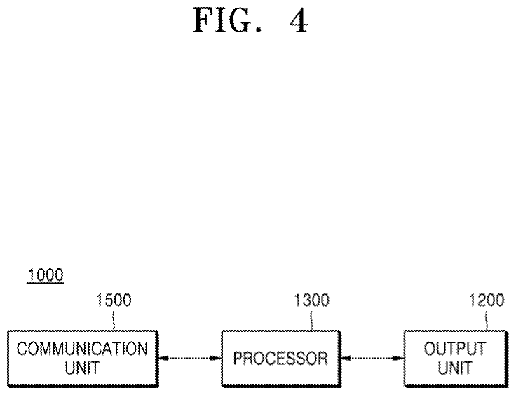

FIG. 4 is a block diagram illustrating the electronic apparatus 1000, according to an embodiment.

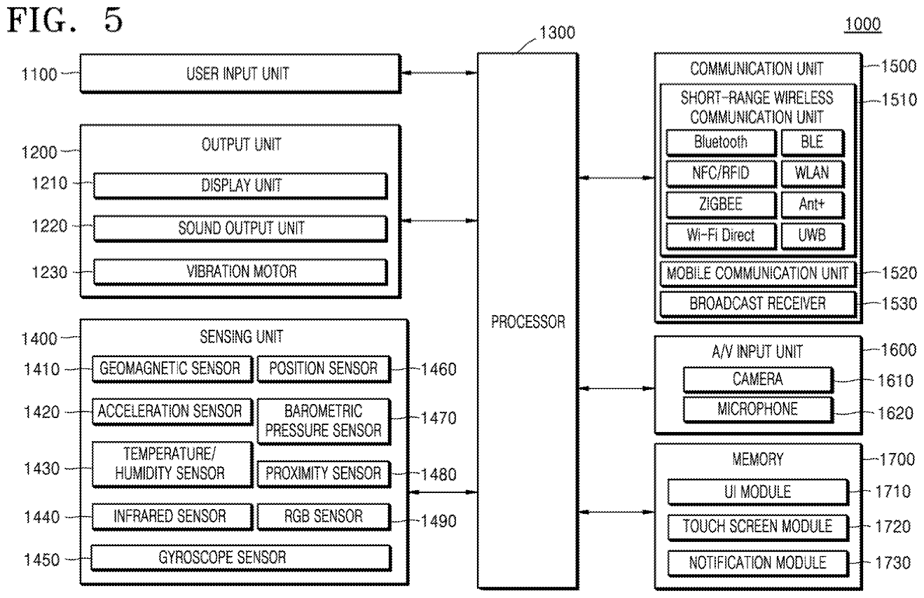

FIG. 5 is a block diagram illustrating a detailed configuration of the electronic apparatus 1000, according to an embodiment.

Referring to FIG. 4, the electronic apparatus 1000 may include a processor 1300, a communication unit (or communication interface) 1500, an output unit (or output interface) 1200. However, although the electronic apparatus 1000 is shown as including certain components, the one or more embodiments are not limited thereto. The electronic apparatus 1000 may be implemented by more or less components than the components illustrated in FIG. 4.

Referring to FIG. 5, the electronic apparatus 1000 according to some embodiments may further include a user input unit 1100, a sensing unit 1400, an audio/video (AN) input unit 1600, and a memory 1700, in addition to the processor 1300, the communication unit 1500, and the output unit 1200.

The user input unit 1100 refers to an interface for inputting data for a user to control the electronic apparatus 1000. For example, the user input unit 1100 may include, but is not limited to, a keypad, a dome switch, a touch pad (a touch capacitive type, a pressure resistive type, an infrared beam sensing type, a surface acoustic wave type, an integral strain gauge type, a piezoelectric type, or the like), a jog wheel, a jog switch, or the like.

According to an embodiment, the user input unit 1100 may train a personal model in the electronic apparatus 1000 or may perform a user input for performing various operations using the personal model.

The output unit 1200 may output an audio signal, a video signal, or a vibration signal, and the output unit 1200 may include the display 1210, a sound output unit 1220, and a vibration motor 1230.

The display 1210 displays information processed by the electronic apparatus 1000. According to an embodiment, a display unit 1210 may display information about a personal model trained according to an embodiment or a result of an operation performed according to the trained personal model.

When the display 1210 and a touch pad form a layer structure to constitute a touch screen, the display 1210 may be used as an input device as well as an output device. The display 1210 may include at least one of a liquid crystal display, a thin film transistor-liquid crystal display, an organic light-emitting diode, a flexible display, a three-dimensional (3D) display, or an electrophoretic display. The electronic apparatus 1000 may include two or more displays 1210 according to an implementation type of the electronic apparatus 1000.

The sound output unit 1220 outputs audio data received from the communication unit 1500 or stored in the memory 1700. According to an embodiment, a sound output unit 1220 may output information about a personal model trained according to an embodiment or a result of an operation performed according to the trained personal model.

The vibration motor 1230 may output a vibration signal. In addition, when a touch is input to a touch screen, the vibration motor 1230 may output a vibration signal. According to an embodiment, a vibration motor 1230 may output information about a personal model trained according to an embodiment or a result of an operation performed according to the trained personal model.

The processor 1300 generally controls overall operations of the electronic apparatus 1000. For example, the processor 1300 may take overall control of the user input unit 110, the output unit 1200, the sensing unit 1400, the communication unit 1500, the A/V input unit 1600, and the like by executing programs stored in the memory 1700.

The electronic apparatus 1000 may include at least one processor 1300. For example, the electronic apparatus 1000 may include various types of processors such as a central processing unit (CPU), a graphics processing unit (GPU), and a neural processing unit (NPU).

The processor 1300 may be configured to process instructions of a computer program by performing basic arithmetic, logic, and input/output operations. The instructions may be provided from the memory 1700 to the processor 1300 or may be received via the communication unit 1500 and provided to the processor 1300. For example, the processor 1300 may be configured to execute the instructions according to program codes stored in a recording device such as memory.

The processor 1300 according to an embodiment may train a personal model based on personal data and group model data. According to an embodiment, the personal model may be trained based on first information and second information, wherein the first information indicates a constituent element of the personal model trained based on the personal data, and the second information indicates a constituent element of the personal model trained based on the group model data collected with respect to a plurality of users of a group to which a user of the electronic apparatus 1000 belongs.

The electronic apparatus 1000 according to an embodiment of the disclosure may train a personal model by determining a first weight value and a second weight value to be respectively applied to first information and second information based on reliability of the first information, and applying the first weight value and the second weight value to the first information and the second information.

For example, as the reliability of first information is lower, the first weight value is determined to be a lower value than the second weight value, and thus even when reliability of a personal model refined using only personal data is low, a personal model refined with high reliability may be obtained using along with the personal model refined according to group model data.

The sensing unit 1400 may sense a state of the electronic apparatus 1000 or a state around the electronic apparatus 1000 and may transfer sensed information to the processor 1300.

The sensing unit 1400 may include, but is not limited to, at least one of a geomagnetic sensor 1410, an acceleration sensor 1420, a temperature/humidity sensor 1430, an infrared sensor 1440, a gyroscope sensor 1450, a position sensor (for example, a global positioning system (GPS)) 1460, a barometric pressure sensor 1470, a proximity sensor 1480, or an RGB sensor (illuminance sensor) 1490.

The communication unit 1500 may include one or more components to communicate with a server 2000 or an external device. For example, the communication unit 1500 may include a short-range wireless communication unit 1510, a mobile communication unit 1520, and a broadcast receiver 1530.

The short-range wireless communication unit 1510 may include, but is not limited to, a Bluetooth communication unit, a Bluetooth Low Energy (BLE) communication unit, a near field communication unit, a wireless local area network (WLAN) (Wi-Fi) communication unit, a Zigbee communication unit, an Infrared Data Association (IrDA) communication unit, a Wi-Fi Direct (WFD) communication unit, an ultra wideband (UWB) communication unit, an Ant+ communication unit, or the like.

The mobile communication unit 1520 transmits a radio signal to and receives a radio signal from at least one of a base station, an external terminal, or a server on a mobile communication network. Here, the radio signal may include various types of data according to transmission and reception of a voice call signal, a video call signal, or a text/multimedia message.

The broadcast receiver 1530 receives a broadcast signal and/or broadcast-related information from outside the electronic apparatus 1000 via a broadcast channel. The broadcast channel may include a satellite channel or a terrestrial channel. The electronic apparatus 1000 may not include the broadcast receiver 1530, according to an implementation example.

The communication unit 1500 according to an embodiment of the disclosure may transmit and receive, to and from external apparatus, data for training a personal model. For example, the communication unit 1500 may receive, from the external apparatus, group model data collected with respect to a plurality of users of a group to which a user belongs. ILG may be obtained based on the group model data.

The A/V input unit 1600 is for inputting an audio signal or a video signal and may include a camera 1610, a microphone 1620, and the like. The camera 1610 may obtain an image frame of a still image, a moving image, or the like through an image sensor in a video call mode or a shooting mode. An image captured through the image sensor may be processed by the processor 1300 or a separate image processing unit. The microphone 1620 receives an external sound signal that is input thereto and processes the sound signal into electrical sound data.

Sound data or video data generated by the A/V input unit 1600 according to an embodiment of the disclosure may be used as personal data for training a personal model. The disclosure is not limited to the above example, the sound data or the video data may be used according to various methods for training a personal model.

The memory 1700 may store programs for processing and control performed by the processor 1300 and may also store data that is input to or output from the electronic apparatus 1000.

The memory 1700 according to an embodiment may store data for training a personal model. For example, the memory 1700 may store personal data and group model data for training a personal model.

The memory 1700 may include at least one of a flash memory type storage medium, a hard disk type storage medium, a multimedia card micro type storage medium, card type memory (for example, Secure Digital (SD) memory, extreme Digital (XD) memory, or the like), random access memory (RAM), static random access memory (SRAM), read-only memory (ROM), electrically erasable programmable read-only memory (EEPROM), programmable read-only memory (PROM), magnetic memory, a magnetic disk, or an optical disk.

The programs stored in the memory 1700 may be classified into a plurality of modules, for example, a UI module 1710, a touch screen module 1720, a notification module 1730, and the like, according to functions thereof.

The UI module 1710 may provide a specialized UI, a graphical user interface (GUI), or the like interworking with the electronic apparatus 1000, on an application basis. The touch screen module 1720 may sense a touch gesture of the user on a touch screen and may transfer information about the touch gesture to the processor 1300. The touch screen module 1720 according to some embodiments may recognize and analyze a touch code. The touch screen module 1720 may be configured as separate hardware including a controller.

To sense a touch or a proximity touch with respect to the touch screen, various sensors may be arranged inside or near the touch screen. An example of a sensor for sensing a touch with respect to the touch screen includes a tactile sensor. The tactile sensor refers to a sensor sensing a contact with a particular object to an extent felt by a human or to a higher extent. The tactile sensor may sense various pieces of information, such as roughness of a contact surface, hardness of a contact object, and a temperature of a contact point.

The touch gesture of the user may include tap, touch and hold, double tap, drag, panning, flick, drag and drop, swipe, or the like.

The notification module 1730 may generate a signal for notifying the occurrence of an event of the electronic apparatus 1000. The notification module 1730 may cause the output unit 1200 to notify a user of an event. For example, the notification module 1730 may cause the display unit 1210 to display information to notify a user of an event and/or the sound output unit 1220 to output audio signal to notify a user of an event under the control of the processor 1300.

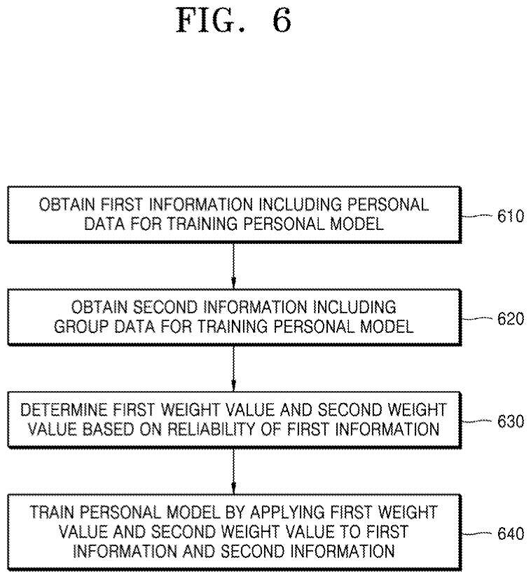

FIG. 6 is a flowchart illustrating a method of training a personal model, according to an embodiment.

Referring to FIG. 6, in operation 610, the electronic apparatus 1000 may obtain first information including personal data for training a personal model. The electronic apparatus 1000 may train a personal model based on personal data. The electronic apparatus 1000 according to an embodiment may obtain ILI which is first information indicating a constituent element of the trained personal model as a result of training the personal model.

In operation 620, the electronic apparatus 1000 may obtain second information including group data for training the personal model. The electronic apparatus 1000 may obtain ILG which is second information indicating a constituent element of the trained personal model by training the personal model of a user based on group model data collected with respect to a plurality of users of a group to which the user belongs.

The group model data according to an embodiment may include information related to a plurality of personal models trained based on personal data respectively collected with respect to the plurality of users. For example, the group model data may include information about constituent elements of personal models respectively corresponding to the plurality of users.

In operation 630, the electronic apparatus 1000 may determine a first weight value and a second weight value to be respectively applied to the first information and the second information, based on reliability of the first information. The reliability of the first information according to an embodiment may indicate reliability of the personal model trained based on the personal data.

The reliability of the first information according to an embodiment may be a value indicating a degree to which an operation according to the personal model corresponds to the user's intention.

Thus, the reliability of the first information according to an embodiment may be determined based on information about the personal data, which affects training of the personal model, or information related to a training context of the personal model.

For example, the reliability of the first information may be determined based on at least one of an amount of the personal data used to obtain the first information, a magnitude of a loss function indicating a difference between observation information and prediction information which are used to obtain the first information, the number of iterations for training the personal model based on the first information and the second information, or a correlation between the user and the plurality of users belonging to the group. For example, if the magnitude of a loss function indicating a difference between observation information and prediction information is closer to 0, then it may be determined that the reliability of the first information is high. As another example, if a correlation between the user and the plurality of users belonging to the same group is high, it may be determined that the reliability of the first information is also high.

Because the first weight value and the second weight value according to an embodiment may be determined as values relative to each other according to the reliability of the first information, whether the correlation between the user and the plurality of users belonging to the group to which the user belongs is high or not relates to the second information corresponding to the second weight value, but may be used to determine the reliability of the first information.

The first weight value and the second weight value according to an embodiment may be determined so that the sum of the two weight values is 1. For example, in response to the first weight value being determined based on the reliability, the second weight value may be determined as a value obtained by subtracting the first weight value from 1.

In operation 640, the electronic apparatus 1000 may train the personal model by applying the first weight value and the second weight value determined in operation 630 to the first information and the second information, respectively.

According to an embodiment, according to Equation 3 described above, a result of adding the first information and the second information to which the first weight value and the second weight value are applied may be obtained as a constituent element of the personal model trained according to an embodiment.

According to an embodiment, even when reliability of the personal model refined using only the personal data is low, the personal model refined with high reliability may be obtained by using along with the personal model refined according to the group model data.

The device-readable storage media may be provided in the form of non-transitory storage media. Here, the term “non-transitory storage media” is a tangible device and only means that it does not include a signal (e.g., electromagnetic wave), and the term does not distinguish between a case where data is stored semi-permanently in a storage media and a case where data is stored temporarily in a storage media. For example, the “non-transitory storage media” may include a buffer in which data is temporarily stored.

According to an embodiment, the methods according to the embodiments disclosed herein may be provided while included in a computer program product. The computer program product may be traded as merchandise between a seller and a purchaser. The computer program product may be distributed in the form of a device-readable storage medium (e.g., compact disc read only memory (CD-ROM)), or may be distributed (e.g., downloaded or uploaded) online through an application store (e.g., Play Store™) or directly between two user devices (e.g., smartphones). In the case of the online distribution, at least a part of the computer program product (e.g., downloadable app) may be temporarily stored in a device-readable storage medium such as a server of a manufacturer, a server of an application store, or a memory of a relay server, or may be temporarily generated.

In addition, the “unit” in the present disclosure may be a hardware component such as a processor or a circuit, and/or a software component to be executed by a hardware component such as a processor.

It will be understood by one of ordinary skill in the art that the embodiments of the disclosure are provided for illustration and may be implemented in different ways without departing from the spirit and scope of the disclosure. Therefore, it should be understood that the foregoing embodiments are provided for illustrative purposes only and are not to be construed in any way as limiting the disclosure. For example, each component described as a single type may be implemented in a distributed manner, and likewise, components described as being distributed may be implemented as a combined type.

The scope of the disclosure should be defined by the appended claims and equivalents thereof, and any changes or modifications derived from the appended claims and equivalents thereof should be construed as falling within the scope of the disclosure.

What is claimed is:

1. A method of training a personal model of a user, performed by an electronic apparatus, the method comprising:
obtaining first information comprising personal data of the user represented as a first constituent element of the personal model;
obtaining second information comprising group data of a plurality of users in a group to which the user belongs, represented as a second constituent element of the personal model;
determining a first weight value and a second weight value to be respectively applied to the first information and the second information based on reliability of the first information; and
training the personal model based on the first information and the second information to which the first weight value and the second weight value are respectively applied.

2. The method of claim 1, wherein the reliability of the first information indicates a degree to which an operation according to the personal model corresponds to a user preference.

3. The method of claim 1, wherein the reliability of the first information is determined based on at least one from among an amount of the personal data used to obtain the first information, a magnitude of a loss function indicating a difference between observation information and prediction information which are used to obtain the first information, a number of iterations for which the personal model is trained based on the first information and the second information, and a correlation between the plurality of users and the user.

4. The method of claim 1, wherein the first weight value and the second weight value are determined so that a sum of the first weight value and the second weight value is equal to 1.

5. The method of claim 1, wherein the group data comprises information related to a plurality of personal models trained based on pieces of personal data respectively collected with respect to the plurality of users.

6. The method of claim 5, wherein the information related to the plurality of personal models comprises constituent elements of the plurality of personal models and an out-degree with respect to each of the plurality of personal models, and
wherein the out-degree indicates a number of personal models among the plurality of personal models affecting at least one personal model among the plurality of personal models.

7. The method of claim 1, wherein the plurality of users are grouped based on a similarity between pieces of personal data of each of the plurality of users.

8. An electronic apparatus for training a personal model of a user, the electronic apparatus comprising:
at least one processor configured to:
control a communication interface to obtain first information comprising personal data of the user represented as a first constituent element of the personal model;
control the communication interface to obtain second information comprising group data of a plurality of users in a group to which the user belongs, represented as a second constituent element of the personal model;
determine a first weight value and a second weight value to be respectively applied to the first information and the second information based on reliability of the first information;
train the personal model based on the first information and the second information to which the first weight value and the second weight value are respectively applied, train the personal model; and
control an output interface to output a result of an operation performed based on the trained personal model.

9. The electronic apparatus of claim 8, wherein the reliability of the first information indicates a degree to which the operation according to the personal model corresponds to a user preference.

10. The electronic apparatus of claim 8, wherein the reliability of the first information is determined based on at least one from among an amount of the personal data used to obtain the first information, a magnitude of a loss function indicating a difference between observation information and prediction information, which are used to obtain the first information, a number of iterations for which the personal model is trained based on the first information and the second information, and a correlation between the plurality of users and the user.

11. The electronic apparatus of claim 8, wherein the first weight value and the second weight value are determined so that a sum of the first weight value and the second weight value is equal to 1.

12. The electronic apparatus of claim 8, wherein the group data comprises information related to a plurality of personal models trained based on pieces of personal data respectively collected with respect to the plurality of users.

13. The electronic apparatus of claim 12, wherein the information related to the plurality of personal models comprises constituent elements of the plurality of personal models and an out-degree with respect to each of the plurality of personal models, and
wherein the out-degree indicates a number of personal models among the plurality of personal models affecting at least one personal model among the plurality of personal models.

14. The electronic apparatus of claim 8, wherein the plurality of users are grouped based on a similarity between pieces of personal data of each of the plurality of users.

15. A non-transitory computer-readable recording medium having recorded thereon a program for implementing the method of claim 1.
